(19) United States
(12) Patent Application Publication
(10) Pub. No.: US 2004/0071059 A1
(43) Pub. Date: Apr. 15, 2004

(54) Multi-channel reproducing apparatus and multi-channel reproducing loudspeaker apparatus

(76) Inventors: Atsushi Kikuchi, Fukushima (JP); Katsuya Tanaka, Fukushima (JP)

Correspondence Address: DICKSTEIN SHAPIRO MORIN & OSHINSKY LLP, 2101 L STREET NW, WASHINGTON, DC, 20037-1526, US

(21) Appl. No.: 10/396,384

(22) Filed: Mar. 26, 2003

(30) Foreign Application Priority Data
Jun. 18, 2002 (JP) 2002-177370

(51) Int. Cl. G11B 7/005

(52) U.S. Cl. 369/47.23; 369/47.24; 369/47.16; 369/47.2

(57) ABSTRACT

The object of the present invention is to provide multi-channel reproducing apparatuses and multi-channel reproducing loudspeaker apparatuses that can be easily connected to one another. In the multi-channel reproducing apparatus 1, a DSP 6 converts an inputted audio signal to audio signals for a plurality of channels, adds channel identification information to each audio signal and multiplexes the audio signals to generate a multi-channel reproducing signal. The DSP 6 supplies the multi-channel reproducing signal to a plurality of multi-channel reproducing loudspeaker apparatuses 20₁ to 20ₙ that are dispersedly arranged. These multi-channel reproducing loudspeaker apparatuses 20₁ to b 0ₙ input the multi-channel reproducing signal from an input terminal 20a and output the signal to outside from an output terminal 20b. Each loudspeaker apparatuses 20₁ to 20ₙ extracts and reproduces the audio signal of the channel assigned thereto from among the multi-channel reproducing signals inputted from a decoder 11 and outputs audio sound from a loudspeaker 16.

### BACKGROUND OF THE INVENTION

This invention relates to a multi-channel reproducing system.

FIG. 6 is a schematic diagram of a conventional multi-channel reproducing system. As shown in the drawing, the multi-channel reproducing system includes a multi-channel reproducing apparatus 100 and a plurality of loudspeakers 103 to 108.

The multi-channel reproducing apparatus 100 has a reproducing apparatus 101 such as an LD (Laser Disc) player or a DVD (Digital Versatile Disc) player, and an amplifier 102 for amplifying an audio signal for each of a plurality of channels outputted from the reproducing apparatus 101. The amplifier 102 has an output terminal for each of a plurality of audio channels, and the loudspeakers 103 to 108 are connected to the audio channels corresponding to the output terminals.

In an example shown in FIG. 6, output terminals for 5.1 channels are provided to the multi-channel reproducing apparatus 100, and the loudspeakers 103 to 108 are connected to the audio channels corresponding to the each output terminal. Here, the loudspeakers 103 to 108 are arranged around a listening point. The loudspeakers 103 to 108 for outputting the audio signals of the 5.1 channels have a configuration, for example in which a low-frequency sound (SWch) loudspeaker 108 corresponding to the audio signals for a 0.1 channel is added to 5 channels of a front left (Lch) loudspeaker 103, a front center (Cch) loudspeaker 104, a front right (Rch) loudspeaker 105, a rear left surround (SLch) loudspeaker 106 and a rear right surround (SRch) loudspeaker 107.

Such a conventional multi-channel reproducing system is disclosed in Japanese Laid-open Patent Application 2000-3354300 and Japanese Laid-open Patent Application 2001-352599, for example.

### SUMMARY OF THE INVENTION

When the conventional multi-channel reproducing system is used to reproduce multi-channel audio signals, the loudspeakers 103 to 108 must be directly connected to the amplifier 102 through each connection cable as shown in FIG. 6. Particularly in the case of a system for reproducing surround audio sound, the loudspeakers 103 to 108 are arranged with certain intervals among them around the listening point. Therefore, the connection cables for connecting the loudspeakers 103 to 108 to the amplifier 102 get elongated, and wiring becomes complicated.

The present invention contemplates the problems described above. The object of the present invention is to provide a multi-channel reproducing apparatus and a multi-channel reproducing loudspeaker apparatus that can be easily connected to one another.

To solve the problems above, the multi-channel reproducing apparatus of the present invention processes an inputted audio signal by a signal processing unit to generate a multi-channel reproducing signal, and supplies this signal to multi-channel reproducing loudspeaker apparatuses that are arranged dispersedly. The signal processing unit converts the inputted audio signal to audio signals for a plurality of channels, adds channel identification information to each audio signal and multiplexes the audio signals to generate the multi-channel reproducing signal.

The multi-channel reproducing loudspeaker apparatus of the present invention receives the multi-channel reproducing signal generated by multiplexing audio signals having channel identification information added thereto for a plurality of channels and outputs the inputted multi-channel reproducing signals to outside. The multi-channel reproducing loudspeaker apparatus extracts and reproduces the audio signal of the channel assigned thereto from among the inputted multi-channel reproducing signals and outputs audio sound from its loudspeaker.

### BRIEF DESCRIPTION OF THE DRAWINGS

FIG. 1 is a diagram for explaining a schematic configuration of a multi-channel reproducing system applied an embodiment of the present invention;

FIG. 2 is a diagram for explaining a configuration example of data of a multi-channel reproducing signal;

FIG. 3 is a diagram for explaining a connection wiring example of the multi-channel reproducing system applied to an embodiment of the present invention;

FIG. 4 is an explanatory view useful for explaining another connection example of the multi-channel reproducing system according to an embodiment of the invention;

FIG. 5 shows an example of a connection cable for connecting configuration apparatus of a multi-channel reproducing system;

FIG. 6 is a diagram for explaining a schematic configuration of a conventional multi-channel reproducing system according to the prior art; and

FIG. 7 is a diagram for explaining a configuration of a digital audio signal inputted to DSP 6.

### DESCRIPTION OF THE PREFERRED EMBODIMENTS

An embodiment of the present invention will be explained below.

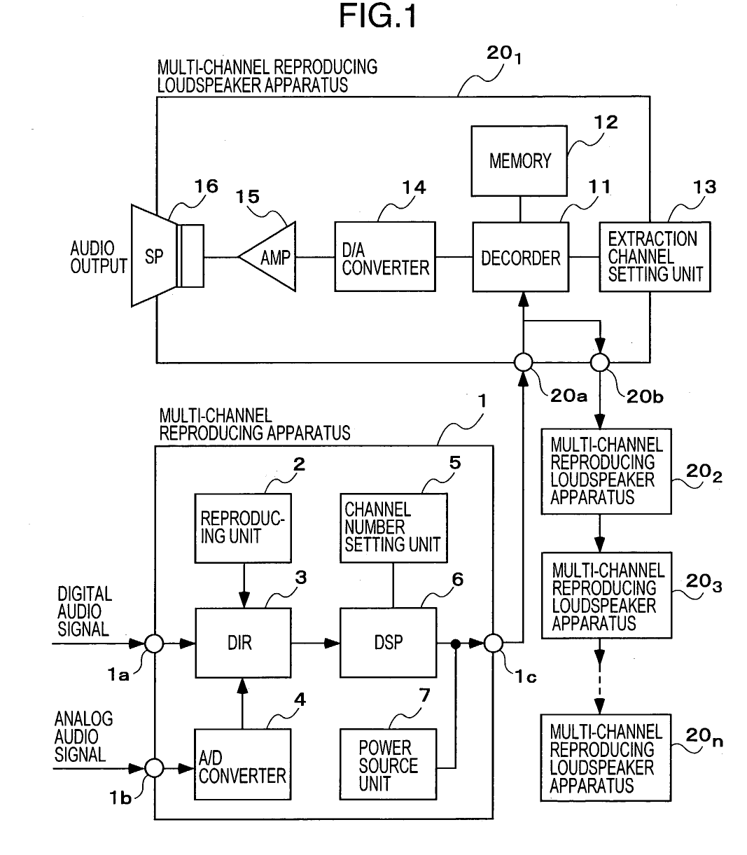

FIG. 1 is a schematic configuration of a multi-channel reproducing system applied to an embodiment of the present invention.

As showing in the drawing, the multi-channel reproducing system of this embodiment includes a multi-channel reproducing apparatus 1 and multi-channel reproducing loudspeaker apparatuses 20₁ to 20ₙ.

The multi-channel reproducing apparatus 1 generates and outputs multi-channel reproducing signals including of audio signals of a plurality of channels. As shown in the drawing, the multi-channel reproducing apparatus 1 has an input terminal 1a for a digital audio signal, an input terminal 1b of an analog audio signal, an output terminal 1c of a multi-channel reproducing signal, a reproducing unit 2 having an output function of the digital audio signal, such as a DVD player, an input selection unit (DIR) 3, an A/D converter 4 for executing A/D conversion of the analog audio signal inputted to the input terminal 1b to the digital audio signal, a channel number setting unit 5, aDSP (DigitalSignal Processor) 6 and a power source unit 7 for supplying power to each part of the multi-channel reproducing apparatus 1.

The DIR 3 selects any one of the digital audio signal inputted to the input terminal la, the digital audio signal outputted from the A/D converter 4 and the digital audio signal outputted from the reproducing unit 2.

The channel number setting unit 5 sets the audio channel number of the multi-channel reproducing signal outputted from the multi-channel reproducing apparatus 1.

The DSP 6 executes a variety of processing such as decoding, reproducing separation regulation, addition of reverberant sound, conversion of the audio channel number, compression, amplification, addition of a sync signal, for the digital audio signal outputted from the DIR 3, and generates and outputs a multi-channel reproducing signal.

Each of the multi-channel reproducing loudspeaker apparatuses 20₁ to 20ₙ extracts the reproducing signal of the audio channel assigned thereto from the multi-channel reproducing signal outputted from the multi-channel reproducing apparatus 1, and reproduces and outputs audio sound according to the reproducing signal extracted. As shown in the drawing, each multi-channel reproducing loudspeaker apparatus 20₁ to 20ₙ includes an input terminal 20a of the multi-channel reproducing signal, an output terminal 20b of the multi-channel reproducing signal inputted to the input terminal 20a, a decoder 11, a memory 12 for temporarily storing an output of the decoder 11, an extraction channel setting unit 13, a D/A converter 14 for executing D/A conversion of the digital audio signal to the analog audio signal, an amplifier 15 for amplifying the analog audio signal outputted from the D/A converter 14 and a loudspeaker 16 for outputting audio sound according to the analog audio signal amplified by the amplifier 15.

The extraction channel setting unit 13 sets the audio channel to be outputted as audio sound from the loudspeaker 16 to the decoder 11.

The decoder 11 extracts the reproducing signal of the audio channel set by the extraction channel setting unit 13 from the multi-channel reproducing signal inputted to the input terminal 20a, executes decoding process and restores the reproducing signal to the digital audio signal of the audio channel.

In the multi-channel reproducing system having the configuration described above, the input terminal 20a of the first multi-channel reproducing loudspeaker apparatus 20₁ is connected the output terminal 1c of the multi-channel reproducing apparatus 1 through the connection cable. The input terminal 20a of the ith (2≦i ≦n) multi-channel reproducing loudspeaker apparatus 20ᵢ is connected to the output terminal 20b of the multi-channel reproducing loudspeaker apparatus 20ᵢ₋₁ through the connection cable. In consequence, the multi-channel reproducing apparatus 1 and the multi-channel reproducing loudspeaker apparatuses 20₁ to 20ₙ are connected to one another in a daisy chain.

Here, when the multi-channel reproducing signal has 5.1 channels, the multi-channel reproducing system has six multi-channel reproducing loudspeaker apparatuses 20₁ to 20₆ for example. In this case, the six multi-channel reproducing loudspeaker apparatuses 20₁ to 20ₙ respectively function as a front center (Cch) loudspeaker unit, a front left (Lch) loudspeaker unit, a low-frequency sound (SWch) loudspeaker unit, a rear left surround (SLch) loudspeaker unit, a rear right surround (SRch) loudspeaker unit and a front right (Rch) loudspeaker unit.

Next, the operation of the multi-channel reproducing system having the configuration described above will be explained.

In the multi-channel reproducing apparatus 1, the DIR 3 selects any one of the digital audio signal inputted to the input terminal la, the digital audio signal outputted from the A/D converter 4 and the digital audio signal outputted from the reproducing unit 2 according to an instruction of an operator inputted through an operation panel, not shown in FIG. 1, for example, and outputs the selected digital audio signal to the DSP 6. Receiving this digital audio signal, the DSP 6 executes process such as decoding, reproducing separation regulation and addition of reverberant sound for the inputted digital audio signal. Further, the DSP 6 changes and compresses the audio channel number of the inputted digital audio signal to the audio channel number set by the channel number setting unit 5. The DSP 6 then puts channel identification information (identification number, for example) to the audio signal (reproducing signal) compressed for each audio channel, generates multi-channel reproducing signals by conducting time division multiplexing with the sync signal and outputs the signal from the output terminal 1c.

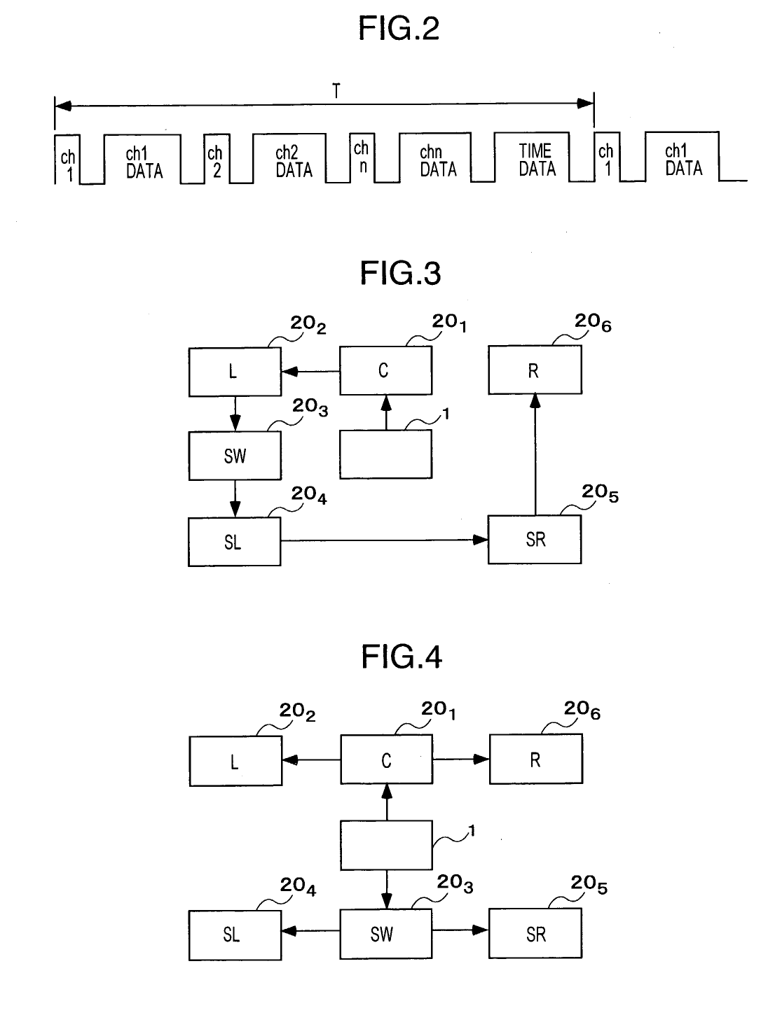

FIG. 2 is a diagram for explaining a configuration of the multi-channel reproducing signal outputted from the DSP 6. In the drawing, symbols ch1, ch2 and chn represent channel identification information. Symbols ch1 DATA, ch2 DATA and chn DATA represent the reproducing signals of the audio channels to which the channel identification information ch1, ch2 and chn are assigned, respectively. The term “Time DATA” represents a sync signal for outputting the audio signals of chl DATA to chn DATA in synchronism, and symbol T represents a data transfer cycle.

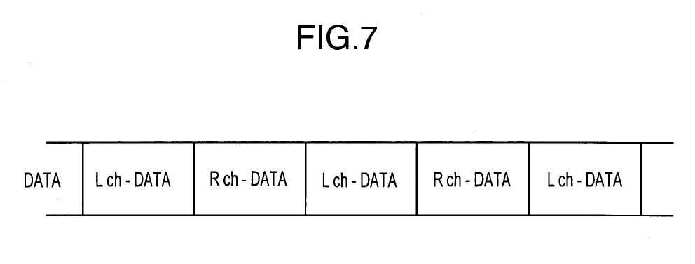

FIG. 7 is a diagram for explaining a configuration of the digital audio signal inputted to the DSP 6. In FIG. 7, Lch-DATA represents data of the left channel and Rch-DATA does data of the right channel.

The digital audio signal inputted to the DSP 6 is the 2-channel digital audio signal shown in FIG. 7 and when the audio channel number set by the channel number setting unit 1 is 5, the DSP 6 executes matrix process for the inputted digital audio signal for decoding and converts the digital audio signal to the 5-channel digital audio signal. The 5-channel digital audio signal acquired is compressed and subjected to time division multiplexing.

When the digital audio signal decoded by the DSP 6 is 5 channels and the audio channel number set by the channel number setting unit 1 is 3 channels, the DSP 6 executes down-mix process for the decoded digital audio signal of the 5 channels and converts it to the digital audio signal of the 3 channels. The DSP 6 compresses and subjects the resulting 3-channel digital audio signal to time division multiplexing.

Incidentally, loudspeaker driving power from the power source unit 7 may be supplied from the multi-channel reproducing apparatus 1 to the multi-channel reproducing loudspeaker apparatuses 20₁ to 20ₙ together with the multi-channel reproducing signals through the connection cables that connect the multi-channel reproducing apparatus 1 to the multi-channel reproducing loudspeaker apparatuses 20₁ to 20ₙ and the multi-channel loudspeaker apparatuses 20₁ to 20ₙ to one another.

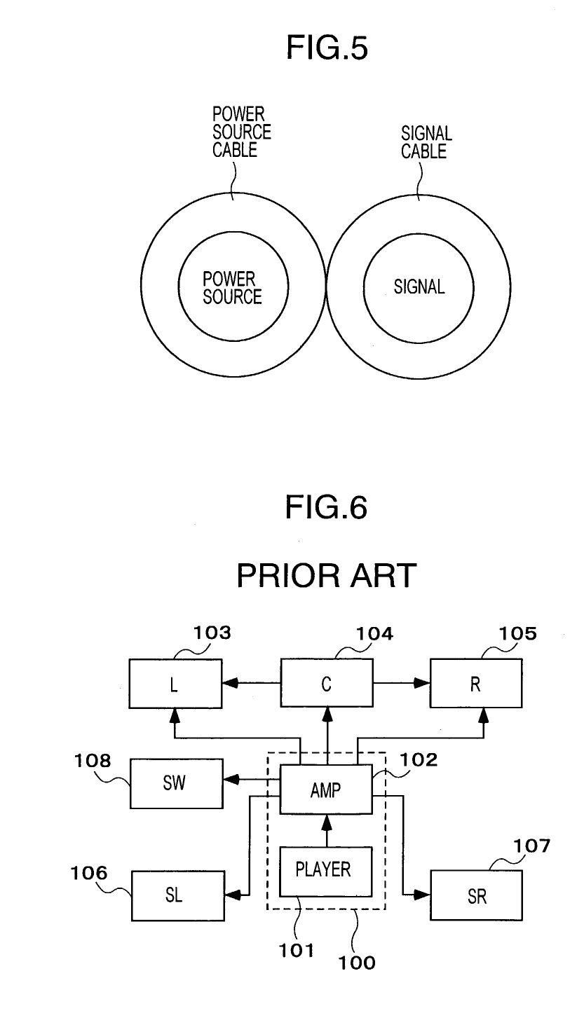

FIG. 5 shows an example of the connection cable for connecting the multi-channel reproducing apparatus 1 to the multi-channel reproducing loudspeaker apparatuses 20₁ to 20ₙ and for connecting the multi-channel reproducing loudspeaker apparatuses 20₁ to 20ₙ to one another. The drawing shows the case where the connection cable is a bundle of two coaxial cables. A core wire and an outer conductor of one of the coaxial cables supply driving power, and a core wire and an outer conductor of the other coaxial cable transfer the multi-channel reproducing signals. According to this power supply system, the connection cable can be constructed in a shape similar to the conventional loudspeaker cable. Further, power and the multi-channel reproducing signal can be transferred by one set of cables.

When each of the multi-channel reproducing loudspeaker apparatuses 20₁ to 20ₙ has its own power source, the multi-channel reproducing signal can be transmitted from the multi-channel reproducing apparatus 1 to the multi-channel reproducing loudspeaker apparatuses 20₁ to 20ₙ by use of an optical cable or a pin cable.

In the multi-channel reproducing loudspeaker apparatuses 20₁ to 20ₙ, on the other hand, the multi-channel reproducing signal outputted from the multi-channel reproducing apparatus 1 is inputted to the decoder 11 through the input terminal 20a and outputted through the output terminal 20b. The decoder 11 extracts the sync signal and the reproducing signal having identification information of the audio channel set by the extraction channel setting unit 13 from the multi-channel reproducing signals inputted, stores them in the memory 12, expands the reproducing signal stored in the memory 12 and restores it to the digital audio signal. The digital audio signal restored is outputted according to the sync signal stored in the memory 12. This digital audio signal is converted to the analog audio signal through the D/A converter 14, amplified by the amplifier 15 and then outputted as audio sound from the loudspeaker 16.

In the manner described above, each of the multi-channel reproducing loudspeaker apparatuses 20₁ to 20ₙ outputs the audio signal of the audio channel assigned to itself in synchronism with the audio signals outputted from other multi-channel reproducing loudspeaker apparatuses 20₁ to 20ₙ.

According to the embodiment, when multi-channel reproducing is made by use of a plurality of multi-channel reproducing loudspeaker apparatuses 20₁ to 20ₙ, these multi-channel reproducing loudspeaker apparatuses 20₁ to 20ₙ can be connected in the chain form and therefore complicated wiring of the connection cables can be prevented. The multi-channel reproducing signal having the multi-channel identification information is outputted to a plurality of multi-channel reproducing loudspeaker apparatuses 20₁ to 20ₙ. On the other hand, these multi-channel reproducing loudspeaker apparatuses 20₁ to 20ₙ extract and reproduce the reproducing signals of the audio channels assigned thereto. Therefore, the surround audio signals can be reproduced and outputted.

The embodiment described above has been explained about the case where the multi-channel reproducing loudspeaker apparatuses 20₁ to 20ₙ are connected in the chain form. However, but the invention is not particularly limited to this. For example, the multi-channel reproducing loudspeaker apparatuses 20₁ to 20ₙ may be divided into a plurality of series and connected in the chain form by providing a plurality of output terminals 1c to the multi-channel reproducing apparatus 1. Alternatively, when a plurality of output terminals 20b is provided to at least one of the multi-channel reproducing loudspeaker apparatuses 20₁ to 20ₙ, the other multi-channel reproducing loudspeaker apparatuses 20₁ to 20ₙ may be divided into a plurality of series and connected in the chain form by using at least one of multi-channel reproducing loudspeaker apparatuses 20₁ to 20ₙ as a branching point.

FIG. 3 is a diagram for explaining the connection arrangement of the multi-channel reproducing loudspeaker apparatuses 20₁ to 20ₙ in the embodiment described above. In this example, the front center (Cch) loudspeaker unit 20₁, the front left (Lch) loudspeaker unit 20₂, the low-frequency sound (SWch) loudspeaker unit 20₃, the rear left surround (SLch) loudspeaker unit 20₄, the rear right surround (SRch) loud speaker unit 20₅ and the front right (Rch) loudspeaker unit 20₆ are connected in the chain form to the multi-channel reproducing apparatus 1.

FIG. 4 is a diagram for explaining a modified example of the connection arrangement of the multi-channel reproducing loudspeaker apparatuses 20₁ to 20ₙ in the embodiment described above. In this example, two output terminals 1c are provided to the multi-channel reproducing apparatus 1, and two output terminals 20b are provided to each of the front center (Cch) loudspeaker unit 20₁ and the low-frequency sound (SWch) loudspeaker unit 20₃. The front center (Cch) loudspeaker unit 20₁ and the low-frequency sound (SWch) loudspeaker unit 20₃ are connected in a radial form to the multi-channel reproducing apparatus 1. The front left (Lch) loudspeaker unit 20₂ and the front right (Rch) loudspeaker unit 20₆ are connected in the radial form to the front center (Cch) loudspeaker unit 20₁. The rear left surround (SLch) loudspeaker unit 20₄ and the rear right surround (SRch) loudspeaker unit 20₅ are connected in the radial form to the low-frequency sound (SWch) loudspeaker unit 20₃.

In this embodiment, the multi-channel reproducing signals having the multi-channel identification information and the sync signal are outputted to a plurality of multi-channel reproducing loudspeaker apparatuses 20₁ to 20ₙ. On the other hand, the multi-channel reproducing loudspeaker apparatuses 20₁ to 20ₙ extract only the reproducing signal of the audio channel assigned thereto among the multi-channel reproducing signals on the basis of the information set by the extraction channel setting unit 13, and reproduce it in synchronism with the sync signal. Therefore, free connection arrangement becomes possible without being limited by the connection sequence of the multi-channel reproducing loudspeaker apparatuses 20₁ to 20ₙ.

The embodiment described above has been explained on the premise that the multi-channel reproducing apparatus 1 transfers the sync signal to multi-channel reproducing loudspeaker apparatuses 20₁ to 20ₙ. However, when the transfer cycle T shown in FIG. 2 is set to 0.1 second or below, for example, transfer of the sync signal can be omitted. In this case, deviation of about 0.1 second occurs between the output timing of the multi-channel reproducing loudspeaker apparatuses 20₁ to 20ₙ to which the first channel is assigned and the output timing of multi-channel reproducing loudspeaker apparatuses 20₁ to 20ₙ to which the nth (last) channel is assigned. Nonetheless, deviation of such a level does not impart any offensive feel to a listener of the multi-channel audio signals.

When the multi-channel reproducing loudspeaker apparatuses 20₁ to 20ₙ need not to output the surround audio signals in synchronism with other multi-channel reproducing loudspeaker apparatus 20₁ to 20ₙ that is, when the multi-channel reproducing apparatuses 1 need not simultaneously output the audio signals of the channels assigned to a plurality of multi-channel reproducing loudspeaker apparatuses 20₁ to 20ₙ (when each of the multi-channel reproducing loudspeaker apparatuses 20₁ to 20ₙ is assigned to a separate room), the multi-channel reproducing loudspeaker apparatus 20₁ to 20ₙ can be outputted the audio signals of the channels assigned in advance without relying on the sync signal. In this case, the multi-channel reproducing loudspeaker apparatuses 20₁ to 20ₙ can be simplified and the production cost can be reduced.

In the embodiment described above, the DSP 6 of the multi-channel reproducing apparatus 1 compresses the digital audio signals of a plurality of audio channels and subjects them to time division multiplexing to generate the multi-channel reproducing signals. However, the invention is not limited to this method but may generate the multi-channel reproducing signals by other multiplexing systems such as compression and time division multiplexing, code division multiplexing.

As described above, the present invention can provide multi-channel reproducing apparatuses and multi-channel reproducing loudspeaker apparatuses that can connected be easily connected mutually.

What is claimed is:

1. A multi-channel reproducing apparatus for generating a multi-channel reproducing signal and supplying the multi-channel reproducing signal to a plurality of multi-channel reproducing loudspeaker apparatuses arranged dispersedly, comprising:
a signal process unit for converting an inputted audio signal to audio signals for a plurality of channels, adding channel identification information to each of the audio signals and multiplexing them to generate a multi-channel reproducing signal.

2. A multi-channel reproducing apparatus according to claim 1, further comprising:
a selection unit for selecting an audio signal source of the audio signal to be inputted to said signal process unit from among a plurality of audio signal sources.

3. A multi-channel reproducing apparatus according to claim 1, wherein said signal processing unit compresses each of the audio signals for a plurality of channels converted, adds channel identification information to each compression signal and subjects the compression signals to time division multiplexing to generate a multi-channel reproducing signal.

4. A multi-channel reproducing apparatus according to claim 3, wherein
said signal processing unit generates the multi-channel reproducing signal by subjecting each compression signal having channel identification information added thereto to time division multiplexing with a sync signal.

5. A multi-channel reproducing loudspeaker apparatus for outputting audio sound according to multi-channel reproducing signals, wherein
said multi-channel reproducing signal is generated by multiplexing audio signals for a plurality of channels each having channel identification information added thereto, and said multi-channel reproducing loudspeaker apparatus includes:
an input terminal of the multi-channel reproducing signal;
at least one of output terminal for outputting the multi-channel reproducing signal inputted to said input terminal to outside; and
a reproducing process unit for extracting the audio signal of the channel assigned thereto from among the multi-channel reproducing signals inputted to said input terminal, reproduces the audio signal extracted and outputs audio sound from said loudspeaker.

6. A multi-channel reproducing loudspeaker apparatus according to claim 5, wherein
said multi-channel reproducing signal is multiplexed with a sync signal in addition to the audio signals for a plurality of channels, and
said reproducing processing unit extracts the audio signal of the channel assigned thereto from among the multi-channel reproducing signals inputted to said input terminal, stores the audio signal extracted in a memory, and reproduces and audio-outputs the audio signal stored in said memory in synchronism with the sync signal contained in the multi-channel reproducing signals.

7. A multi-channel reproducing loudspeaker apparatus according to claim 5, wherein
said multi-channel reproducing loudspeaker apparatuses are connected to one another in a chain form through said input terminal and said output terminal.
